(19) United States
(12) Patent Application Publication
(10) Pub. No.: US 2011/0035432 A1
(43) Pub. Date: Feb. 10, 2011

(54) SYSTEM, SERVER DEVICE, AND METHOD FOR SHARING FILES BETWEEN SERVER DEVICE AND CLIENT TERMINAL

(75) Inventors: KAI-HO HSIUNG, Tu-Cheng (TW); TENG-YU TSAI, Tu-Cheng (TW); CHIA-HUNG CHIEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/611,144

(22) Filed: Nov. 3, 2009

(30) Foreign Application Priority Data
Aug. 4, 2009 (CN) 200910305186.0

(51) Int. Cl. G06F 15/16

(52) U.S. Cl. 709/203; 709/219

(57) ABSTRACT

A method is used for sharing files from a server device to a client terminal, and the method includes the following steps. The server device sends an instruction with a download path to the client terminal. The server device receives an instruction response and a requirement from the client terminal The server device sends a requirement response to the client terminal The server device transfers the files to the client terminal

### BACKGROUND

1. Technical Field

The present disclosure relates to a system, a server device, and a method for sharing files between a server device and a client terminal

2. Description of Related Art

Now, there are many client terminals, such as notebook computers, desktop computers, digital photo frames and so on, in households. Usually, many files, such as audio files, video files, and pictures are duplicated among the many terminals consuming a lot of storage space. So a method is desired to share the files, which are stored in only one of the client terminals.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a server device and a plurality of client terminals communicating with the server device via a network in accordance with an embodiment.

FIG. 2 is a block diagram of the server device and one client terminal communicating with the server device via the network of FIG. 1.

FIG. 3 is a flow chart of a method for sharing files from the server device to the client terminal of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

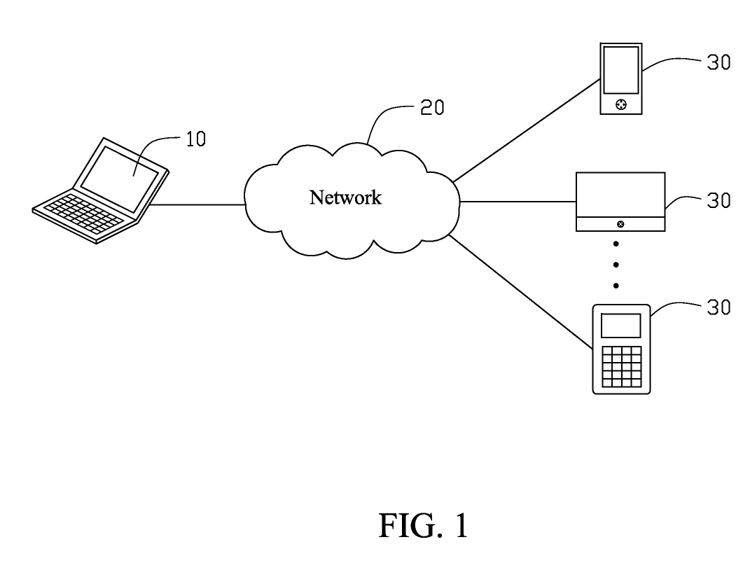

FIG. 1 illustrates a server device 10 communicating with a plurality of client terminals 30 via a network 20. The server device 10 stores a plurality of media files, such as audio files, video files, image files, and so on. The server device 10 may be, for example, a notebook computer, a desktop computer, or a server computer. The client terminals 30 may be, for example, digital photo frames, or smart telephones, etc. The network may be an intranet, for example.

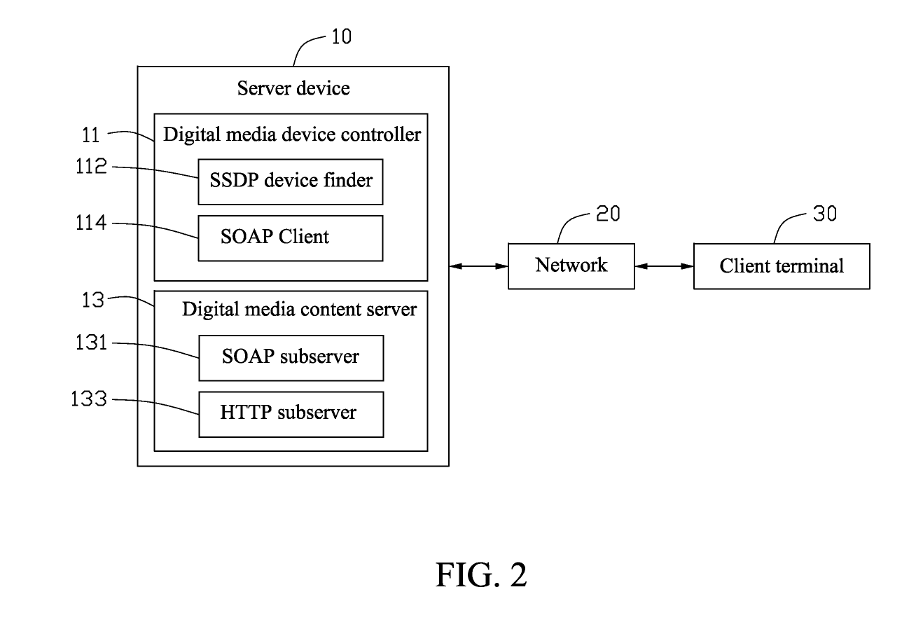

FIG. 2 illustrates the server device 10 communicating with one of the client terminals 30. The server device 10 includes a digital media device controller 11 and a digital media content server 13. The digital media device controller 11 includes a Simple Service Discovery Protocol (SSDP) device finder 112, and a Simple Object Access Protocol (SOAP) client 114.

SSDP provides a mechanism which network clients can use to discover network services. Clients can use SSDP with little or no static configuration. SSDP uses User Datagram Protocol (UDP) unicast and multicast packets to advertise available services.

SOAP is a protocol specification for exchanging structured information in the implementation of Web Services in computer networks. It relies on Extensible Markup Language (XML) as its message format, and it usually relies on other Application Layer protocols (most notably Remote Procedure Call (RPC) and HTTP) for message negotiation and transmission. SOAP can form the foundation layer of a web services protocol stack, providing a basic messaging framework upon which web services can be built.

The SSDP device finder 112 is capable of searching for the client terminals 30 in the network 20, and getting information of the client terminals 30 after finding the client terminal 30. In one embodiment, the information of the client terminals 30 includes names and/or locations. The SOAP client 114 is capable of sending instructions to the client terminals 30, and getting the status of performing the instructions. In one embodiment, the instructions include setting accounts and passwords of the client terminals 30 to access the server device 10, and sending instructions with download path to the client terminals 30.

The digital media content server 13 includes a SOAP subserver 131. The SOAP subserver 131 is capable of getting the current status of the client terminals 30. In one embodiment, the status includes current spare storage space of the client terminals 30. In addition, the SOAP subserver 131 is capable of receiving requirements from the client terminals 30 and sending requirement responses to the client terminal 30.

The digital media content server 13 further includes a Hypertext Transfer Protocol (HTTP) subserver 133. HTTP is a request/response standard as is typical in client-server computing. A client is the computer used by an end-user, and the server is the computer hosting a web site. The client submitting HTTP requests is referred to as the user agent. The responding server, which stores or creates resources such as HTML files and images, is called the origin server. In between the user agent and origin server may be several intermediaries, such as proxies, gateways, and tunnels. In one embodiment, the HTTP subserver 133 is capable of storing the media files, and transferring the media files to the client terminals 30.

Each of the client terminals 30 usually includes Universal Plug and Play (UPNP) units, and is capable of sending instruction responses after receiving the instructions from the SOAP client 114. The client terminal 30 is also capable of sending requirements to access the server device 10.

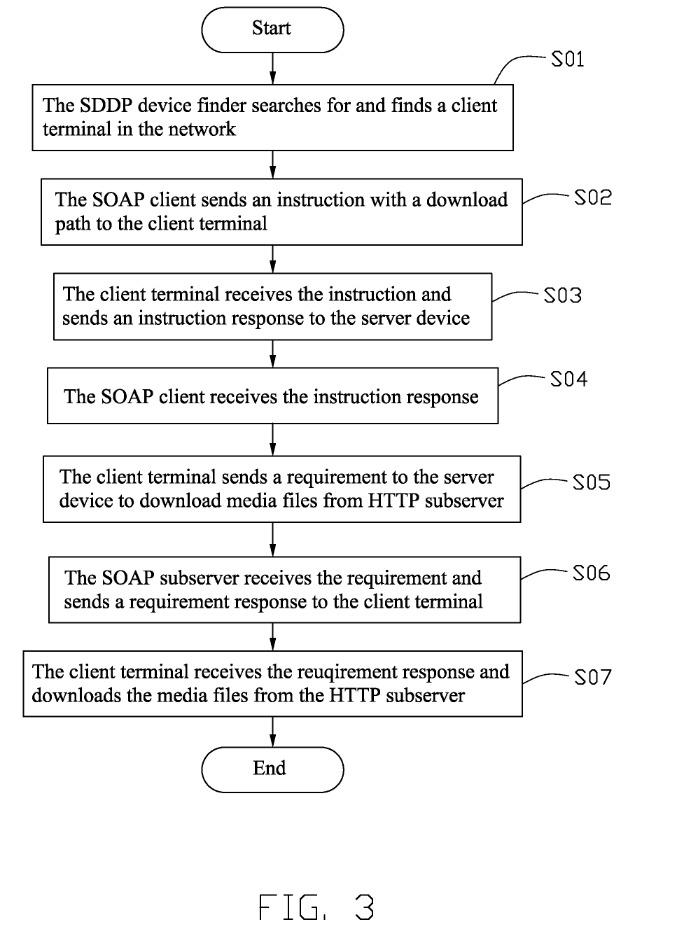

FIG. 3 is a flow chart illustrating a method for the client terminal 30 to receive media files from the server device 10.

In block S01, the SSDP device finder 112 finds client terminals 30 (only one terminal 30 is described hereinafter as an example) in the network 20.

In block S02, the SOAP client 114 sends an instruction with a download path to the client terminal 30.

In block S03, the client terminal 30 receives the instruction, and sends an instruction response to the server device 10.

In block S04, the SOAP client 114 receives the instruction response.

In block S05, the client terminal 30 sends a requirement to the server device 10 for downloading media files.

In block S06, the SOAP subserver 131 of the server device 10 receives the requirement and sends a requirement response to the client terminal 10.

In block S07, the client terminal 30 receives the requirement response and downloads the media files according to the download path from the HTTP subserver 133. At this time, the HTTP subserver 133 transfers the media files to the client terminal 30.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for sharing files from a server device to a client terminal, the method comprising:
sending an instruction with a download path to the client terminal by the server device;
receiving an instruction response and a requirement from the client terminal by the server device;
sending a requirement response to the client terminal; and
transferring the files to the client terminal by the server device.

2. The method of claim 1, further comprising: finding the client terminal in a network by the server device before sending the instruction.

3. The method of claim 2, wherein the server device comprises a Simple Service Discovery Protocol device finder capable of searching for the client terminal is in the network.

4. The method of claim 1, wherein the server device comprises a Simple Object Access Protocol (SOAP) client capable of sending the instruction to the client terminal and receiving the instruction response.

5. The method of claim 1, wherein the server device comprises a SOAP subserver capable of receiving the requirement and sending the requirement response.

6. The method of claim 1, wherein the server device comprises a Hypertext Transfer Protocol subserver capable of storing the files therein.

7. A system comprising a server device and a client terminal, the server device being capable of sharing files with the client terminal, the server device comprising:
a Simple Object Access Protocol (SOAP) client capable of sending an instruction with a download path to the client terminal, and receiving an instruction response from the client terminal;
a SOAP subserver capable of receiving a requirement from the client terminal and sending a requirement response to the client terminal; and
a Hypertext Transfer Protocol (HTTP) subserver capable of transferring the files to the client terminal.

8. The system of claim 7, wherein the server device comprises a Simple Service Discovery Protocol device finder capable of searching for and finding the client terminal in a network.

9. The system of claim 7, wherein the client terminal is a digital photo frame.

10. The system of claim 7, wherein the HTTP subserver capable of storing the files therein.

11. A server device, comprising:
a Simple Service Discovery Protocol device finder capable of searching for a client terminal in a network;
a Simple Object Access Protocol (SOAP) client capable of sending an instruction with a download path to the client terminal and receiving an instruction response from the client terminal;
a SOAP subserver capable of receiving a requirement from the client terminal and sending a requirement response to the client terminal; and
a Hypertext Transfer Protocol subserver capable of storing the files therein and transferring the files to the client terminal via the download path.
